(19) United States
(12) Patent Application Publication
(10) Pub. No.: US 2002/0015558 A1
(43) Pub. Date: Feb. 7, 2002

(54) Arrangement and device for optical ray transformation

(76) Inventors: Vitalij Lissotschenko, Dortmund (DE); Alexei Mikhailov, Dortmund (DE)

Correspondence Address: HOFFMAN, WASSON & GITLER, P.C., Suite 522, 2361 Jefferson Davis Highway, Arlington, VA, 22202, US

(21) Appl. No.: 09/900,040

(22) Filed: Jul. 9, 2001

(30) Foreign Application Priority Data
Jul. 28, 2000 (DE) 100 36 787.9

(51) Int. Cl. G02B 6/32

(52) U.S. Cl. 385/34; 385/33

(57) ABSTRACT

An arrangement for optical beam transformation which can be used for imaging of one light source, or several light sources onto the end face of an optical fiber having at least one light source which can emit at least one light beam, and further including an imaging element and at least one device for optical beam transformation. The imaging element can image at least one light beam which has been emitted by at least one light source onto at least one device for optical beam transformation, and at least one light beam can pass at least partially through it, and the device for optical beam transformation on the entry surface and/or on the exit surface of the light beam or beams having at least one concave toroidal refractive surface so that at least the device for optical beam transformation can reflect the cross section of at least one light beam passing through it at least in sections on a plane which is parallel to the propagation direction (z) of the respective section of the light beam.

### BACKGROUND OF THE INVENTION

This invention relates to an arrangement and a device for optical beam transformation. The arrangement can be used for imaging of a light source or several light sources onto the end face of an optical fiber, and it has at least one light source which can emit at least one light beam. It includes an imaging element and at least one device for optical beam transformation. The imaging element can image at least one light beam which has been emitted by the at least one light source onto the at least one device for optical beam transformation and the at least one light beam can pass at least partially through it.

An arrangement and a device of the aforementioned type was shown in European patent specification EP 0 484 276 B1. In the arrangement described therein, the light is focused by several diode lasers which are arranged in a row onto the end face of an optical fiber. Instead of several diode lasers, the light of a laser diode bar can also be imaged with several linear emitting sections which are located in a row onto the end face of the optical fiber. One Abbe-Koenig prism is used as the device for optical beam transformation in the indicated patent specification per component beam of one of the diode lasers. Each of these light beams, with an essentially linear cross section, is turned in each of these Abbe-Koenig prisms by roughly 90°. This rotation of the light beams which occurs from linear light sources, which are arranged in a row, is an especially good idea because as a result of the divergence of the individual component beams in the line direction, intermingling of the individual component beams can take place, which makes effective imaging of the component beams onto the end face of the optical fiber impossible with simple means. The use of an Abbe-Koenig prism to turn the individual component beams is however disadvantageous since the Abbe-Koenig prism is on the one hand an expensive optical component with a very complex structure. On the other hand, the individual component beams must be fed separately from one another into a host of Abbe-Koenig prisms which are next to one another and separated from one another. Based on the necessary splitting into individual component beams or groups of component beams, with the previously known device, the light of a two-dimensional light source cannot be effectively imaged into a stipulated region of space, or in particular, cannot be turned by segments or sections, or can be turned only very incompletely.

Another arrangement and another device of the initially mentioned type are disclosed in European patent application EP 10 06 382 A1. The device described therein for optical beam transformation has an array of cylindrical lens segments with cylinder axes which are tilted by 45° relative to the lengthwise direction of the light source, for example, a laser diode bar. This results in the light beam, or beams, entering the device being turned in sections by 90° during passage through the device. The defect in this device is that imaging errors, such as astigmatic imaging errors, are tolerated by the choice of cylinder surfaces at the entry and/or exit surfaces.

It is an object of the present invention to devise an arrangement and device for optical beam transformation of the initially mentioned type which can be easily and economically produced and which can image without errors.

### SUMMARY OF THE INVENTION

At least one entry surface and/or at least one exit surface of the device for optical beam transformation has at least one concave toroidal refractive surface so that at least one device for optical beam transformation can reflect the cross section of at least one light beam passing through it at least in sections on a plane which is parallel to the propagation direction of the respective section of the light beam. This reflection makes it possible to transform the light proceeding from a linear light source such that, before passage, the segments of the cross section of the light beam which extend in the lengthwise direction of the linear light source extend perpendicularly to the lengthwise direction of the linear light source after passage through the device. Thus, as with the aforementioned devices, for example in a laser diode bar, the divergence of the so-called fast-axis can be exchanged with the divergence of the so-called slow axis. In addition, the choice of concave toroidal refractive surfaces instead of cylinder surfaces can result in imaging errors, especially astigmatic imaging errors, being prevented. To do this, for example, along the torus of the refractive surface, the concave curvature can also vary.

In the arrangement in the present invention, the axis of the torus of this at least one refractive surface can be tilted relative to the lengthwise direction of an essentially linear, or rectangular, cross section of an incident light beam within the plane of the entry and/or the exit surface, preferably at an angle of roughly 45°. Especially at a tilt of the axis of the torus by roughly 45°′ the cross section of the incident light beam is reflected completely, or in segments in itself, such that the divergence of the fast axis is exchanged with that of the slow axis. At least one entry and/or exit surface can have an essentially elongated, preferably essentially rectangular shape, than the axis of the torus of at least one toroidal refractive surface within this surface being tilted at an angle of preferably 45° relative to the lengthwise direction of the surface.

Advantageously, both, at least one entry surface, and at least one exit surface, have concave toroidal refractive surfaces which in the middle propagation direction of the light beams are incident on the device and are located opposite one another. Preferably, at least one entry surface and at least one exit surface, each have a number of concave toroidal refractive surfaces of the same focal length which are located next to one another and parallel to one another. In this way, it is ensured that the light beams emerging from a two-dimensional light source enter the device through the toroidal refractive surfaces located next to one another and emerge again through the opposite toroidal refractive surfaces, all cross sections of the component beams passing through the device being analogously transformed by the same focal lengths of all toroidal refractive surfaces.

According to one preferred embodiment of this invention, the device is made as an essentially cuboidal body, with one entry surface, and one exit surface parallel to one another, their distance to one another corresponding preferably to twice the focal length of the toroidal refractive surfaces. The parallel arrangement of the entry and exit surface ensures that light beams retain their direction after passing through the device. The choice of the distance of the entry and exit surface to be equal to twice the focal length of the toroidal refractive surfaces guarantees that light beams upon passage through the device undergo only one cross sectional transformation, but not focusing or divergence.

According to one alternative preferred embodiment of this invention, the device includes two essentially cuboidal bodies which each have one entry surface and one exit surface which is parallel to it, with a distance to one another which is preferably less than the simple focal length of the toroidal refractive surfaces. These two cuboidal bodies are preferably arranged to one another such that the lens elements formed by the toroidal refractive surfaces which are opposite in one body have a common focal plane between the cuboidal bodies. On the one hand, this ensures that the light beams passing through the device are transformed only with respect to their cross section, but are not focused or widened. Furthermore, due to the focusing of the light beams passing through the device in the common focal plane which is located between the cuboidal bodies light sources with a greater divergence in one direction or light sources with emitting sections which are located nearer one another in one direction can also be handled more effectively so that losses can be reduced in imaging for example onto the end face of an optical fiber.

### BRIEF DESCRIPTION OF THE FIGURES

Advantages and features of this invention become clear using the following description of a preferred embodiment with reference to the attached figures:

FIG. 1a shows an overhead view of an arrangement for optical beam transformation as claimed in the invention;

FIG. 1b shows a side view of the arrangement as shown in FIG. 1a;

FIG. 2a shows an overhead view of a device for optical beam transformation as claimed in the invention;

FIG. 2b shows a view according to the arrow IIb-IIb in FIG. 2a;

FIG. 3a shows a perspective view of a lens element of a device for optical beam transformation as claimed in the invention with a sample beam bundle;

FIG. 3b shows a schematic view of beam transformation with the lens element as shown in FIG. 3a;

FIG. 4 shows a schematic section along line IV-IV in FIG. 2b;

FIG. 5a shows a perspective view of another embodiment of the device as claimed in the invention;

FIG. 5b shows a view according to arrow Vb in FIG. 5a;

FIG. 6 shows a schematic section along line VI-VI in FIG. 5b.

### DETAILED DESCRIPTION OF THE INVENTION

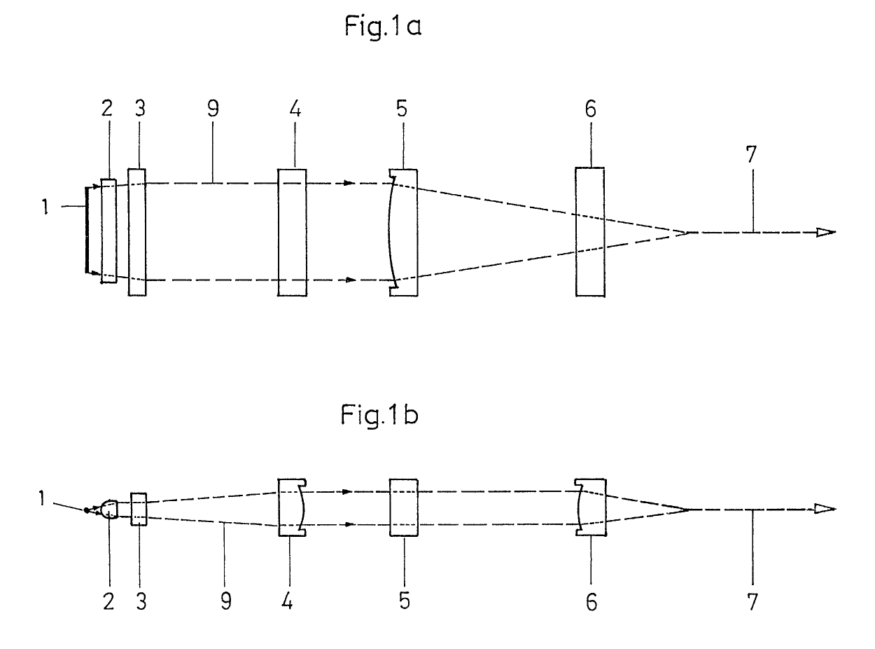

The arrangement for optical beam transformation shown in FIGS. 1a and 1b includes a light source 1 which is made as a laser diode bar and which represents an essentially linear light source. Instead of a linear light source, a point light source or a light source consisting of groups of point sources or a two-dimensional light source with any angle distribution can be used. In FIG. 1a and FIG. 1b the coordinate axes x, y, z are shown for better orientation. The light source 1 extends, for example, essentially in the x direction in which it has for example an extension of 10 mm. Conversely, the extension of the light source 1 in the y direction is roughly 1 micron. The light emitted from the light source 1 in the direction of the y axis has a much greater divergence than in the direction of the x axis. The divergence in the y direction is roughly 0.5 rad, conversely the divergence in the x direction is roughly 0.1 rad. Furthermore, a light source 1 which is made, for example, as a laser diode bar is divided into several emitting sections, for example into 20-25 sections in its lengthwise direction.

At least one light beam 9, which emerges from the light source 1, is collimated in a cylinder lens 2, which extends essentially in the x direction, diffraction-limited such that the divergence in the y direction is only 0.005 rad so that the light behind the cylinder lens 2 runs essentially parallel with respect to the y axis.

In the device 3 for optical beam transformation, which is to be detailed below, the cross section of the incident light is reflected on the surface which is parallel to its propagation direction, so that after emerging from the device 3 the divergence in the y direction is roughly 0.1 rad and the divergence in the x direction is roughly 0.005 rad. One such light beam, which is moderately divergent in the y direction, and which is only insignificantly divergent in the x direction, can be easily focused by focusing elements 4, 5, 6 which are made, for example, as cylinder lenses onto the end of the optical fiber 7 and are coupled into it.

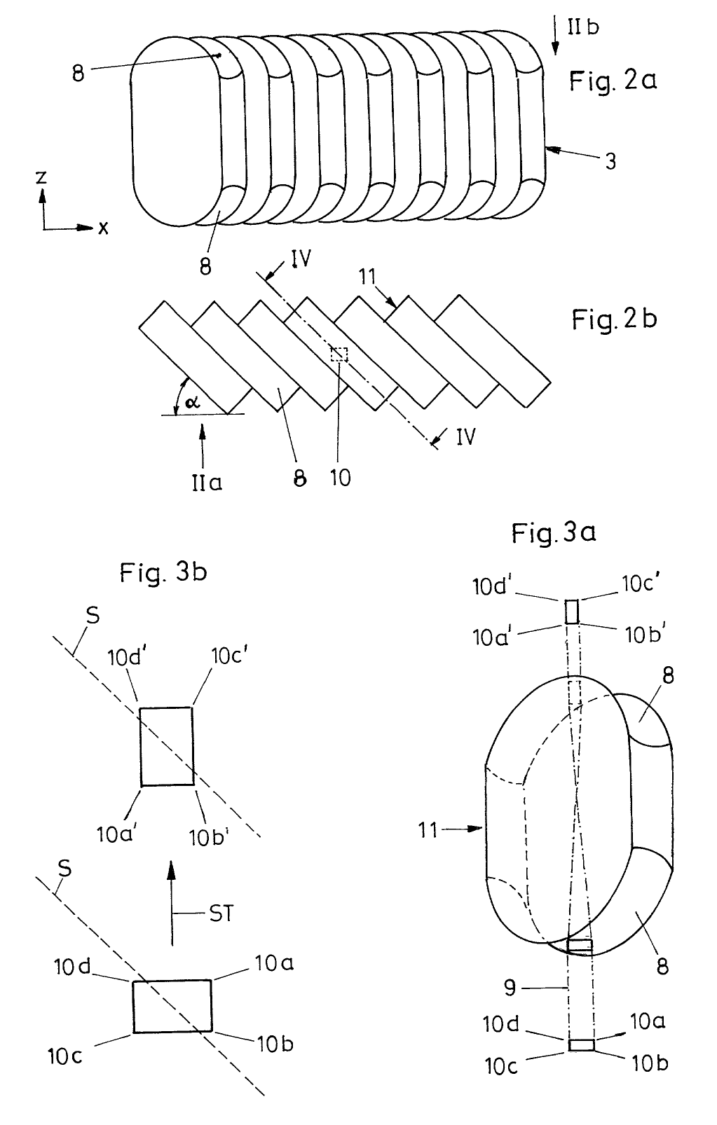

FIGS. 2a and 2b show an embodiment of a device 3 for optical beam transformation. It is an essentially cuboidal block of transparent material on which both on the entry side and also on the exit side there are a host of concave toroidal refractive surfaces 8 which are located parallel to one another. The torus axes of the refractive surfaces 8 include an angle α of 45° with the base side of the cuboidal device 3 which runs in the x direction. FIG. 2b shows the angle α which corresponds to this angle α between the x direction and the lateral border of one of the lens elements 11 perpendicular to the torus axis. In the embodiment shown there are roughly ten concave toroidal refractive surfaces 8 next to one another on each of the two x-y surfaces of the device 3. Two refractive surfaces 8 opposite one another at a time form one lens element 11. Each of the lens elements 11 acts like a biconvex cylinder lens by which the concave transverse curvature of the surface 8, for example, astigmatic imaging errors can be counteracted. FIG. 4 shows that the depth T of the lens elements 11 measured in the z-direction is equal to twice the focal length of each of these essentially biconvex lens elements 11. This corresponds to

T=2Fₙ.

Here T is the depth of the device 3 for optical beam transformation which is made as an array of toroidal lens elements 11 and Fₙ is the focal length of each of the lens elements 11 at a refractive index n of the chosen material of the device 3. FIG. 4 shows a schematic beam path of a light beam 9 which illustrates that each of the lens elements 11 converts a parallel light beam 9 in turn into a parallel light beam 9. It remains to be noted that FIG. 4, like FIG. 6, is intended to only schematically illustrate the beam path and does not represent an exact reproduction of the beam path through the geometric device shown.

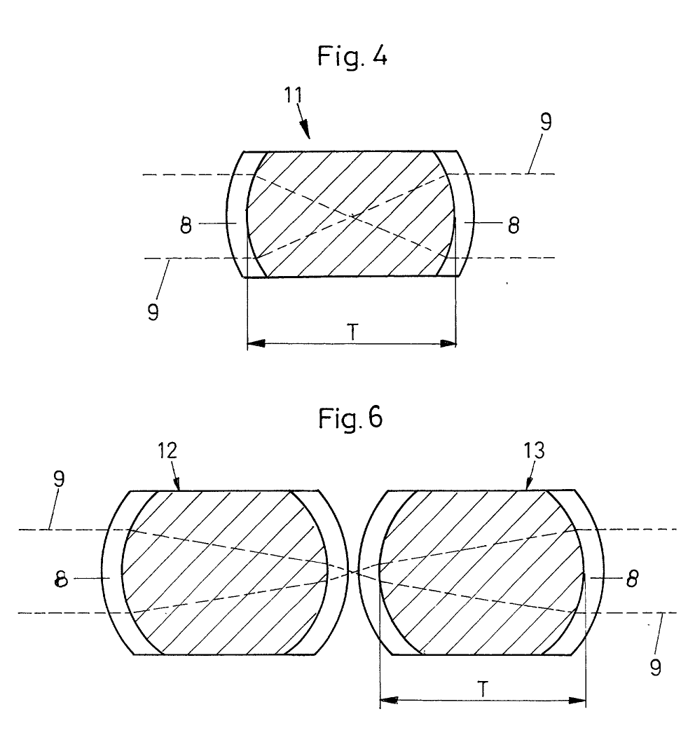

FIGS. 3a and 3b show passage of a light beam 9 which strikes a lens element 11, with a cross section 10 through the device 3 using the example of corner points 10a, b, c, d of the cross section 10. The device 3 is aligned according to the arrangement in FIG. 1 such that the refractive surfaces 8 are essentially x-y surfaces.

FIGS. 3a and 3b show that the cross section 10 of the light beam 9 which is incident on the lens element 11 corresponds to a rectangle which is extended more in the x direction than in the y direction. After passing through the lens element 11 the cross section 10 of the light beam 9 largely corresponds likewise to a rectangle. But it is more extended in the y direction than in the x direction.

The schematic view shown especially in FIG. 3b illustrates that passage of the light beam 9 through the lens element 11 causes the beam transformation which is shown in FIG. 3b by the arrow ST. The beam transformation undertaken by the lens element 11 corresponds to reflection on the mirror plane S which is shown in FIG. 3b, which runs parallel to the beam direction and which is tilted both relative to the x and also the y direction by 45°. In this way, on the one hand the result is that a rectangle extending in the x direction before beam transformation or a line extending beforehand in the x direction after beam transformation is extended in the y direction. Furthermore, the reflection on the mirror plane S causes interchange of the sequence of corner points 10a, 10b, 10c, 10d of the cross section 10 of the beam 9 such that the corner points 10a, 10b, 10c, 10d which beforehand were arranged ascending clockwise, after beam transformation are arranged ascending counterclockwise as corner points 10a′, 10b′, 10c′, 10d′, as is clearly shown in FIG. 3b.

The interchange of the extension in the x direction and the extension in the y direction by means of beam transformation prevents for example component beams which proceed from individual sections of the light source 1 as a result of the divergence which is relatively strong under certain circumstances from overlapping one another in the x direction, since after passage through the device 3 there is only diffraction-limited residual divergence in the x direction, conversely the divergence in the y direction corresponds to the original divergence in the x direction of for example roughly 0.1 rad.

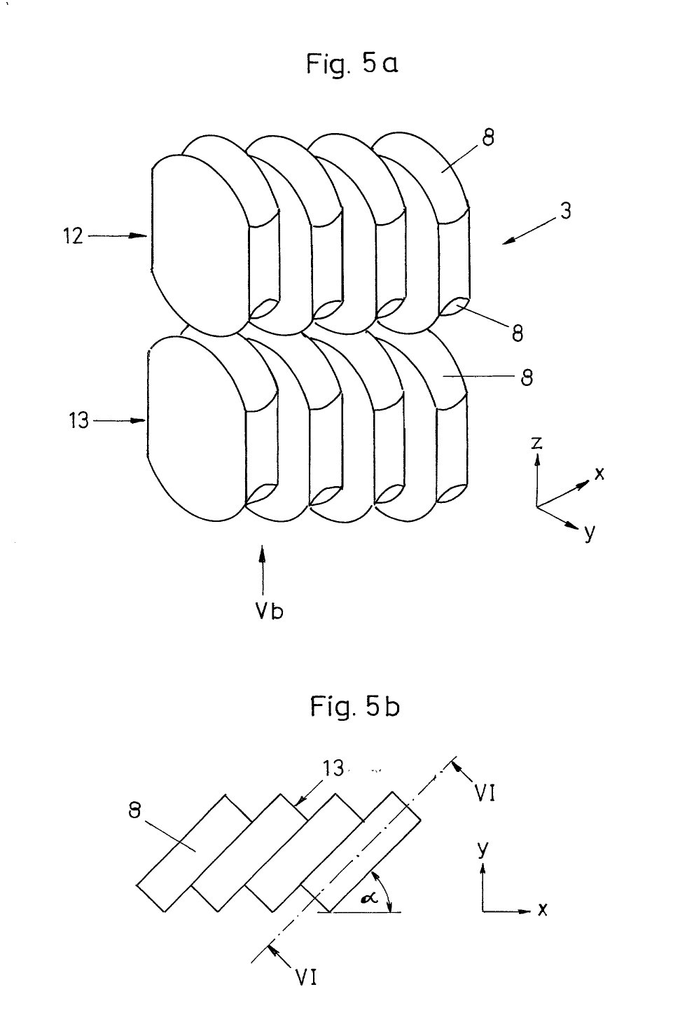

FIG. 5 shows another embodiment of a device 3 for optical beam transformation. Here, instead of an array, two arrays of lens elements 12, 13 are used in which likewise the x-y surfaces are each provided with an array of concave toroidal refractive surfaces 8 which are located at an angle α of the axes of the torus to the base surface of 45°. The angle α in FIG. 5b is equivalent to the angle α in FIG. 2b. But it is apparent from FIG. 6 that these lens elements 12, 13 have a smaller depth T, and the depth of the individual lens elements 12, 13 can be chosen to be smaller here than the simple focal length Fₙ. This is shown by the schematic in FIG. 6. Here it is shown that each of the lens elements 12, 13 at least in sections forms a biconvex lens which each have identical focal lengths so that parallel beam bundles which are incident from the right or left are focused on a common focal plane located between the lens elements 12, 13. Based on the fact that the light beams which are incident in the second lens element 13 proceed from a focal point which lies on the common focal plane, the efficiency of beam transformations increases because the dimension of the light source placed in the focal plane is smaller that the dimension of the group of beams incident on the entry surface of the lens element 12 from the cylinder lens 2. With one such device for optical beam transformation also light sources with a greater divergence or light sources with emitting sections which are located nearer one another in the x direction or one-dimensional or two-dimensional light sources can be handled more effectively so that losses can be reduced.

What is claimed is:

1. An arrangement for optical beam transformation for imaging of at least one light source onto an end face of an optical fiber, comprising the at least one light source which can emit at least one light beam; an imaging element and at least one optical beam transformation device; the imaging element imaging at least one light beam which has been emitted by the at least one light source onto the at least one optical beam transformation device for optical beam transformation, and wherein the at least one light beam can pass at least partially through it, and wherein the optical beam transformation device on an entry surface and/or on an exit surface of the at least one light beam has at least one concave toroidal refractive surface so that at least the optical beam transformation device can reflect a cross section of the at least one light beam passing through it at least in sections on a plane (S) which is parallel to a propagation direction (z) of a respective section of the at least one light beam.

2. The arrangement as claimed in claim 1, wherein the at least one light beam has a linear, or rectangular cross section and wherein an axis of a torus of the at least one concave toroidal surface is tilted relative to a lengthwise direction of the linear, or rectangular cross section of the at least one light beam within a plane (x-y) of an entry or an exit surface, at an angle (α) of approximately 45° or −45°.

3. The arrangement as claimed in claim 1, further comprising at least one focusing element with which the at least one light beam emerging from the optical beam transformation device can be focused onto an end face of the optical fiber.

4. The arrangement as claimed in claim 1, wherein the imaging element is a cylinder lens.

5. An optical beam transformation device having at least one entry surface and at least one exit surface through which at least one light beam to be transformed can pass, wherein the optical beam transformation device on the at least one entry surface or the at least one exit surface, or on both entry and exit surfaces has at least one concave toroidal refractive surface so that the optical beam transformation device can reflect a cross section of a light beam passing through it at least in sections on a plane (S) which is parallel to a propagation direction (z) of a respective section of the light beam.

6. The device as claimed in claim 5, wherein on the at least one entry surface and on the at least one exit surface there are concave toroidal refractive surfaces which in the direction of the middle propagation direction (z) of the at least one light beam are located opposite one another in the device.

7. The device as claimed in claim 5, wherein the at least one entry surface or the at least one exit surface of the device has an essentially elongated shape and wherein the torus axis of at least one toroidal refractive surface is tilted relative to a lengthwise direction of the entry or exit surface within a plane (x-y) of the entry and exit surfaces, at an angle (α) of 45° and/or −45°.

8. The device as claimed in claim 5, wherein the at least one entry surface and the at least one exit surface are provided with a number of concave toroidal refractive surfaces of a same focal length (Fₙ) which are located next to one another and parallel to one another.

9. The device as claimed in claim 8, comprising an essentially cuboidal body with one entry and exit surface at a time essentially parallel to one another, their distance (T) to one another corresponding to twice the focal length (Fₙ) of the concave toroidal refractive surfaces.

10. The device as claimed in claim 8, consisting of two essentially cuboidal bodies, which each have one entry surface and one exit surface which is aligned essentially parallel to it, with a distance (T) to one another which is less than the focal length (Fₙ) of the refractive surfaces.
